(19) United States
(12) Patent Application Publication
(10) Pub. No.: US 2014/0107901 A1
(43) Pub. Date: Apr. 17, 2014

(54) METHOD FOR CONTROLLING SYNCHRONIZATION OF AUTOMATED MANUAL TRANSMISSION

(71) Applicants: HYUNDAI MOTOR COMPANY, Seoul (KR); KIA MOTORS CORP., Seoul (KR)

(72) Inventors: Joung Chul KIM, Suwon-si (KR); Young Min YOON, Seoul (KR)

(73) Assignees: Kia Motors Corp., Seoul (KR); Hyundai Motor Company, Seoul (KR)

(21) Appl. No.: 13/714,097

(22) Filed: Dec. 13, 2012

(30) Foreign Application Priority Data
Oct. 11, 2012 (KR) 10-2012-0112795

(51) Int. Cl. G05D 13/00

(52) U.S. Cl. CPC G05D 13/00
USPC 701/60

(57) ABSTRACT

A method for controlling synchronization of an automated manual transmission includes: a step of dividing synchronization section that divides the entire synchronization section where synchronization is performed into a plurality of synchronization sections in accordance with the speed of the synchronization; a step of setting the rate of change of a target number of revolutions that sets the rate of change of a target number of revolutions of an input shaft in accordance with the speed of the synchronization; and a step of synchronization that performs feedback control such that the rate of change of the number of revolutions of the input shaft is synchronized while following the rate of change of a target number of revolutions.

### CROSS-REFERENCE TO RELATED APPLICATION

The present application claims priority of Korean Patent Application Number 10-2012-0112795 filed Oct. 11, 2012, the entire contents of which application is incorporated herein for all purposes by this reference.

### BACKGROUND OF INVENTION

1. Field of Invention

The present invention relates to a method for controlling synchronization of an automated manual transmission, and more particularly, to a method for controlling synchronization of an automated manual transmission which prevents shock and noise due to synchronization by differently applying a synchronization speed for each section where synchronization is performed.

2. Description of Related Art

In general, in the Automated Manual Transmission (AMT) and Dual Clutch Transmission (DCT) type of vehicles equipped with an automated manual transmission, shifting it automatically performed by an actuator while the vehicles travel, it is possible to provide convenience in driving similar to the automatic transmission and to contribute to fuel efficiency improvement of a vehicle with higher power transmission efficiency than the automatic transmission.

In the process of shifting in the automated manual transmission, when an instruction of shifting the gear, selecting and shifting of a transmission mechanism is performed, and thus shifting to a desired gear can be performed.

In this process, since the automated manual transmission is equipped with a synchronized engagement type of manual shifting mechanism, synchronization by a synchronization engagement mechanism is performed in the process of selecting and shifting of the shifting mechanism, and synchronization control is performed by a predetermined force by an open loop control method.

That is, when the start point of a synchronization section, where synchronizer ring and slip of the shift gear are performed in the synchronization engagement mechanism, is reached, the actuator finishes synchronization by applying a predetermined force to a synchronization device, and then a sleeve engages with a synch gear and the shift gear, thereby finishing shifting.

However, there is a problem in the synchronization control method of the related art in that shock and noise due to the synchronization are generated in the end section of synchronization, because an initially set force is applied from the start to the end section of the synchronization without a detailed control logic, for each section in the process of synchronization.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

The present invention has been made in an effort to solve the above-described problems associated with prior art. Various aspects of the present invention provide for a method for controlling synchronization of an automated manual transmission which prevents shock and noise due to synchronization by differently applying a synchronization speed for each section where synchronization is performed.

Various aspects of the present invention provide for a method for controlling synchronization of an automated manual transmission, including: a step of dividing synchronization section that divides the entire synchronization section where synchronization is performed into a plurality of synchronization sections in accordance with the speed of the synchronization; a step of setting the rate of change of a target number of revolutions that sets the rate of change of a target number of revolutions of an input shaft in accordance with the speed of the synchronization; and a step of synchronization that performs feedback control such that the rate of change of the number of revolutions of the input shaft is synchronized while following the rate of change of a target number of revolutions.

Various aspects of the present invention provide for a method for controlling synchronization of an automated manual transmission, including: a step of dividing synchronization section that divides the entire synchronization section where synchronization is performed into a plurality of synchronization sections in accordance with the speed of the synchronization; a step of setting the rate of change of a target number of revolutions that sets the rate of change of a target number of revolutions of an input shaft to a rotational displacement of an output in accordance with the speed of the synchronization; and a step of synchronization that performs feedback control such that the rate of change of the number of revolutions of the input shaft to the rotational displacement of the output is synchronized while following the rate of change of a target number of revolutions.

In the step of setting the rate of change of a target number of revolutions, the rate of change of a target number of revolutions may be set to be smaller in the earlier synchronization section and the end synchronization section than the middle synchronization section in the entire synchronization section.

In the step of setting the rate of change of a target number of revolutions, the rate of change of a target number of revolutions may be set to be smaller in the end synchronization section than the other synchronization sections in the entire synchronization section.

In the step of setting the rate of change of a target number of revolutions, the gear shifting time can be reduced by setting the synchronization speed as high as possible in the middle synchronization section.

The rate of change of a target number of revolutions and the rate of change of the number of revolutions can be controlled by a change in the amount of slip of the synchronization device.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a diagram illustrating a change in speed of an input shaft due to synchronization control of the related art.

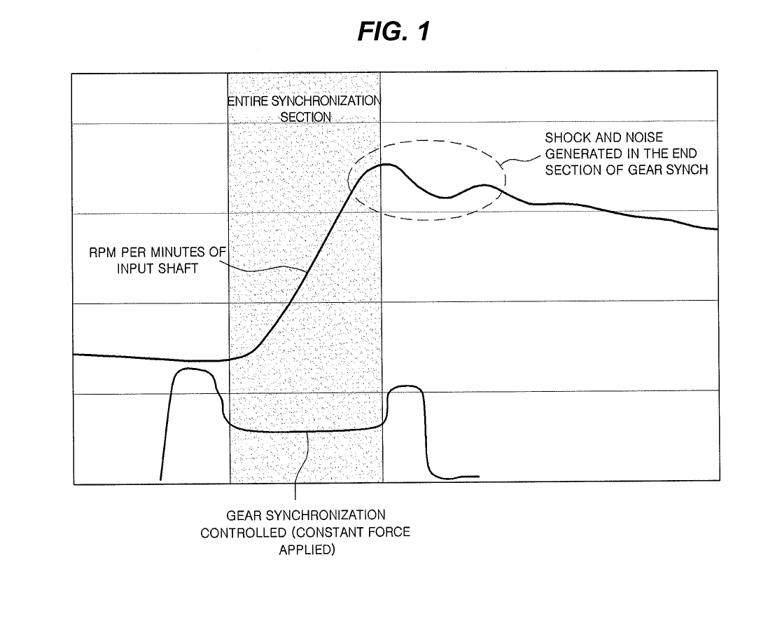

FIG. 2 is a block diagram illustrating an exemplary method for controlling synchronization according to the present invention.

FIG. 3 is a diagram illustrating a change in speed of an input shaft and a synchronization speed for each section according to an exemplary method of controlling synchronization of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

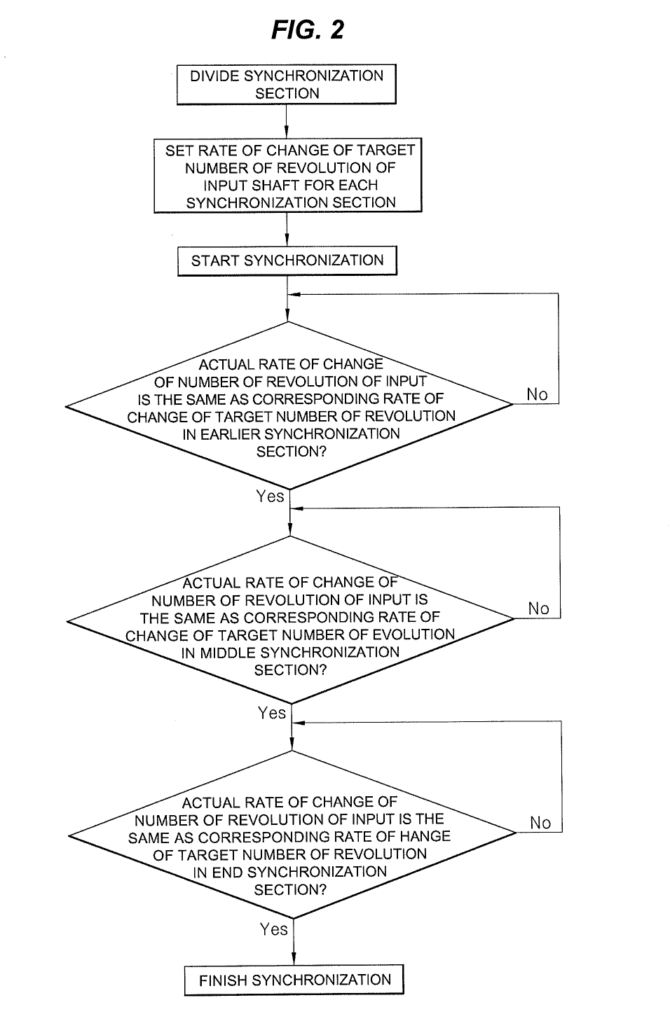

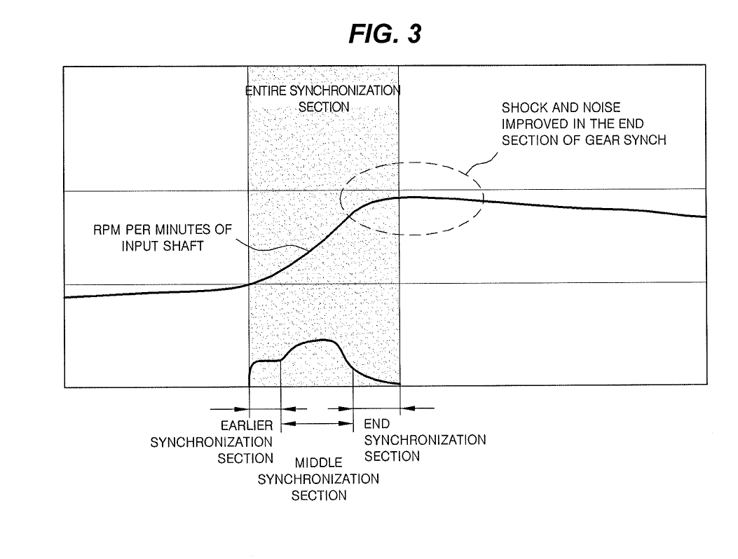

FIG. 2 is a block diagram illustrating a method for controlling synchronization according to the present invention and FIG. 3 is a diagram illustrating a change in a speed of an input shaft and a synchronization speed for each section according to a method of controlling synchronization of the present invention.

Referring to the figures, a method for controlling synchronization of an automated manual transmission according to various embodiments of the present invention includes; a step of dividing synchronization section that divides the entire synchronization section where synchronization is performed into a plurality of synchronization sections in accordance with the speed of the synchronization; a step of setting the rate of change of a target number of revolutions that sets the rate of change of a target number of revolutions of an input shaft in accordance with the speed of the synchronization; and a step of synchronization that performs feedback control such that the actual rate of change of the number of revolutions of the input shaft is synchronized while following the rate of change of a target number of revolutions.

In detail, the section from the start of the synchronization to the end of the synchronization is set as a speed ratio section of 0.0˜1.0 and the synchronization section is divided at a breakpoint where the synchronization speed changes in the speed ratio section. Further, the rate of change of a target number of revolutions of the number of revolutions of the input shaft is set for each synchronization section, and then feedback control of the rate of change of the number of revolutions of the input shaft is performed such that the number of revolutions of the input shaft follows the set rate of change of a target number of revolutions for each synchronization section while the number of revolutions of the input shaft is monitored when the vehicle actually travels.

Meanwhile, a method for controlling synchronization of an automated manual transmission according to various embodiments of the present invention includes; a step of dividing synchronization section that divides the entire synchronization section where synchronization is performed into a plurality of synchronization sections in accordance with the speed of the synchronization; a step of setting the rate of change of a target number of revolutions that sets the rate of change of a target number of revolutions of an input shaft to a rotational displacement of the output in accordance with the speed of the synchronization; and a step of synchronization that performs feedback control such that the actual rate of change of the number of revolutions of the input shaft to the rotational displacement of the output shaft is synchronized while following the rate of change of a target number of revolutions.

In detail, the section from the start of the synchronization to the end of the synchronization is set as a speed ratio of 0.0˜1.0 and the synchronization section is divided at a breakpoint where the synchronization speed changes in the speed ratio section. Further, the rate of change of a target number of revolutions of the number of revolutions of the input shaft to the number of revolutions of the output shaft is set for each synchronization section, and then feedback control of the rate of change of the number of revolutions of the input shaft is performed such that the number of revolutions of the input shaft to the output shaft follows the set rate of change of a target number of revolutions for each synchronization section while the numbers of revolutions of the input shaft and the output shaft are monitored when the vehicle actually travels.

The speed ratio is the ratio of a number of revolution change section, where the speed of the input shaft changes while the current synchronization is performed, to the entire change section where the speed of the input shaft changes while synchronizer ring moves in the process of synchronization.

Further, the hardware structure where the present invention is applied may be an AMT (Automated Manual Transmission) vehicle or a DCT (Dual Clutch Transmission) vehicle, in which synchronization can be controlled by controlling a force by an actuator.

According to the configurations of various embodiments, as the synchronization is performed at different speeds in the synchronization sections in the entire section where the synchronization is performed, it is possible to achieve more precise synchronization control.

As illustrated in FIG. 3, according to the present invention, in the step of setting the rate of change of a target number of revolutions, the rate of change of a target number of revolutions may be set to be smaller in the earlier synchronization section and the end synchronization section than the middle synchronization section in the entire synchronization section.

Further, in the step of setting the rate of change of a target number of revolutions, the rate of change of a target number of revolutions may be set to be smaller in the end synchronization section than the other synchronization sections in the entire synchronization section.

That is, in the earlier synchronization, control is performed such that abnormal vibration or shock is generated in the earlier synchronization by reducing the rate of change of the number of revolutions of the input shaft by reducing the movement speed of the amount of movement of the synchronizer ring, and particularly, precise control is required for control of improving vibration and shock in the end synchronization, so that performance of shift gears is ensured in the end synchronization by reducing the movement speed or the amount of movement of the synchronizer ring as small as possible.

In the step of setting the rate of change of a target number of revolutions, the gear shifting time can be reduced by setting the synchronization speed as high as possible in the middle synchronization section.

That is, after the earlier synchronization, the gear shifting time is reduced by increasing the rate of change of the number of revolutions of the input shaft as large as possible and by increasing the movement speed or the amount of movement of the synchronizer ring as large as possible.

The rate of change of a target number of revolutions and the rate of change of the number of revolutions can be controlled by changing the amount of slip of the synchronization device.

That is, while the synchronizer ring of the synchronization device moves, the synchronization is performed by slip with a shift gear, in which the change in the number of revolutions of the input shaft to the rotational displacement of the output shaft can be controlled by a change of the amount of slip between the synchronizer ring and the shift gear. Therefore, the smaller the rate of change of the amount of slip, the larger the number of revolutions of the input shaft to the rotation displacement of the output shaft, and the rate of change of the number of revolutions of the input shaft increases, whereas the larger the rate of change of the amount of slip, the smaller the number of revolutions of the input shaft to the rotational displacement of the output shaft, so that the rate of change of the number of revolutions of the input shaft decreases.

The rate of change of the number of revolutions of the input shaft is the number of revolution per minute (rpm/t) of the input shaft for unit time and represents the degree of change in the number of revolutions of the input shaft, and the rate of change of the amount of slip is a rotational speed difference (slip rpm/t) of the input shaft to the number of revolutions of the output shaft for unit time and represents the degree of change in the amount of slip.

The operation and effect of the present invention are described in detail with reference to FIGS. 2 and 3.

When an instruction of shifting that corresponds to the speed while a vehicle equipped with an automated manual transmission travels, shifting is performed by selecting and shifting of an actuator and synchronization is first performed by a synchronization device in the process of shifting.

Since the rate of change of the target number of revolutions of the input shaft is set to be small in the earlier synchronization section in the entire synchronization section, the number of revolutions or the amount of slip of the input shaft is feedback-controlled to slowly increase in accordance with the rate of change of the target number of revolutions of the input shaft, which is set in advance.

Thereafter, since the rate of change of the target number of revolutions of the input shaft is set as large as possible in a corresponding middle section, after the earlier section, the number of revolutions or the amount of slip of the input shaft is feedback-controlled to increase and change as fast as possible in accordance with the rate of change of the target number of revolutions of the input shaft.

Since the rate of change of the target number of revolutions of the input shaft is set to be small again in the end synchronization section after the middle synchronization section, the number of revolutions or the amount of slip of the input shaft is feedback-controlled to increase as slow as possible in accordance with the rate of change of the target number of revolutions of the input shaft, which is set in advance.

As described above, according to the method for controlling synchronization of an automated manual transmission of the present invention, since the synchronization speed is set to be different in the synchronization sections divided from the entire synchronization section and feedback control is performed to achieve synchronization in accordance with the set synchronization speed in the synchronization sections when the actual synchronization is performed, more precise control of synchronization can be performed.

In particular, since the rate of change of the target number of revolutions is set to be small in the earlier synchronization, abnormal vibration of shock is prevented in the earlier synchronization, gear shifting time is reduced by making the synchronization speed as high as possible in the middle synchronization section, and then the rate of change of the target number of revolutions is set to be small again in the end synchronization section, so that stable gear shifting performance is ensured in the end synchronization section.

According to the method for controlling synchronization of an automated manual transmission of the present invention, since the synchronization speed is set to be different in the synchronization sections divided from the entire synchronization section and feedback control is performed to achieve synchronization in accordance with the set synchronization speed in the synchronization sections when the actual synchronization is performed, more precise control of synchronization can be performed.

Further, it is possible to prevent abnormal vibration or shock in the earlier synchronization by making the synchronization speed slow in the earlier synchronization, to reduce the gear shifting time by making the synchronization speed as high as possible in the middle synchronization section, and to ensure stable gear shifting performance in the end synchronization by making the synchronization speed slow again in the end synchronization.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A method for controlling synchronization of an automated manual transmission, comprising;
a step of dividing synchronization that divides the entire synchronization section where synchronization is performed into a plurality of synchronization sections in accordance with the speed of the synchronization;
a step of setting the rate of change of a target number of revolutions that sets the rate of change of a target number of revolutions of an input shaft in accordance with the speed of the synchronization; and
a step of synchronization that performs feedback control such that the rate of change of the number of revolutions of the input shaft is synchronized while following the rate of change of a target number of revolutions.

2. A method for controlling synchronization of an automated manual transmission, comprising;
a step of dividing synchronization that divides the entire synchronization section where synchronization is performed into a plurality of synchronization sections in accordance with the speed of the synchronization;
a step of setting the rate of change of a target number of revolutions that sets the rate of change of a target number of revolutions of an input shaft to a rotational displacement of an output in accordance with the speed of the synchronization; and
a step of synchronization that performs feedback control such that the rate of change of the number of revolutions of the input shaft to the rotational displacement of the output is synchronized while following the rate of change of a target number of revolutions.

3. The method of claim 1, wherein in the step of setting the rate of change of a target number of revolutions, the rate of change of a target number of revolutions is set to be smaller in an earlier synchronization section and an end synchronization section than the middle synchronization section in the entire synchronization section.

4. The method of claim 1, wherein in the step of setting the rate of change of a target number of revolutions, the rate of change of a target number of revolutions is set to be smaller in an end synchronization section than the other synchronization sections in the entire synchronization.

5. The method of claim 3, wherein in the step of setting the rate of change of a target number of revolutions, the gear shifting time is reduced by setting the synchronization speed as high as possible in a middle synchronization section.

6. The method of claim 2, wherein the rate of change of a target number of revolutions and the rate of change of the number of revolutions are controlled by a change in the amount of slip of a synchronization device.

7. The method of claim 2, wherein in the step of setting the rate of change of a target number of revolutions, the rate of change of a target number of revolutions is set to be smaller in an earlier synchronization section and an end synchronization section than a middle synchronization section in the entire synchronization.

8. The method of claim 2, wherein in the step of setting the rate of change of a target number of revolutions, the rate of change of a target number of revolutions is set to be smaller in an end synchronization section than the other synchronization sections in the entire synchronization.
